(19) United States
(12) Patent Application Publication
(10) Pub. No.: US 2005/0033638 A1
(43) Pub. Date: Feb. 10, 2005

(54) System and method for advertising compliance

(76) Inventors: Toni-Diane Donnet, El Cajon, CA (US); Joseph N. Lerner, El Cajon, CA (US)

Correspondence Address: NEIL K. NYDEGGER;NYDEGGER & ASSOCIATES, 348 Olive Street, San Diego, CA, 92103, US

(21) Appl. No.: 10/637,120

(22) Filed: Aug. 8, 2003

(51) Int. Cl. G06F 17/60

(52) U.S. Cl. 705/14; 715/507

(57) ABSTRACT

The invention features a method for adapting an advertisement (ad) for a user to be in compliance with applicable jurisdictional requirements requires the user to input product description data and transaction terms. The ad disclosures and layout guidelines that are necessary for compliance are then displayed as text and guidance for a compliant ad. After review by the user, the compliant ad can then be accepted, edited, or saved and color coded for future use or modification.

### FIELD OF THE INVENTION

The present invention pertains generally to methods and systems that are useful for the creation of display, print, online or radio/tv advertisements. More particularly, the present invention pertains to advertisements that are created with computer assistance. The present invention is particularly, but not exclusively, useful for evaluating the advertising data that is input to the computer by a user, and then providing the disclosures and layout guidelines that are necessary for the display, print or radio/tv advertisement to be in legal compliance with applicable jurisdictional requirements.

### BACKGROUND OF THE INVENTION

In light of the many consumer advocacy laws that are now in place, the old commercial axiom of “Caveat Emptor” (i.e. Let the Buyer Beware) has been somewhat qualified by the notion that the buyer needs to be informed. To this end, a plethora of legal requirements (federal, state, and sometimes local) have been enacted for the purpose of at least affording a potential buyer with the opportunity to become informed. A primary focus of government in these attempts to inform the consuming public has been through the regulation of advertising.

From the standpoint of a seller, advertiser or publisher, the requirements that must be satisfied in order for advertising to be legally compliant can often be onerous to implement. On the other hand, non-compliance can be potentially ruinous. Stated differently, despite any actual or perceived administrative burden that may be imposed on a seller by legal compliance requirements, the consequence of non-compliance may be commercially unviable, or simply unacceptable. Unfortunately, insofar as display and liner advertising is concerned, it happens that the requirements for legal compliance will vary greatly, depending on the particular jurisdiction as well as the type and volume of products being sold.

Regardless whether an advertisement is a display, print, online or radio/tv ad, legal compliance for display advertising is of particular interest for a seller or dealer, when the product(s) being sold are not fungible. In particular, the situation can become complicated when the products being sold may be either new or used, may vary in their availability, and may have either standard or customized equipment. An automobile dealership is an exemplary case in point. Such a dealership, for example, will normally sell a variety of types of vehicles. Further, these vehicles will most likely be of several different makes and models. Automobiles, however, are only exemplary. Many other types of products are also characterized by their variety, locations and descriptions. Nevertheless, in each case, whenever such products are being advertised there will typically be a statutory or regulatory requirement that the advertising be legally compliant. Accordingly, descriptive comments and locations need to be filtered for legal compliance under state and federal law.

In light of the above, it is an object of the present invention to provide a computerized method and system that adapts an advertisement (ad) to be in legal compliance with applicable jurisdictional requirements. Another object of the present invention is to provide a computerized method for creating a legally compliant advertisement (ad) that can be subsequently modified to accommodate changes in product(s) description, locations description and/or transaction terms. Yet another object of the present invention is to provide a computerized method and system that adapts an advertisement (ad) to be in legal compliance with applicable jurisdictional requirements which is relatively simple to use and comparatively cost effective.

### SUMMARY OF THE INVENTION

In accordance with the present invention, a computerized system and method for assuring a user that an advertisement (ad) is in legal compliance with applicable jurisdictional requirements is based on a computer program that can be functionally subdivided into four groups. These functional groups include: 1) set up options; 2) data input; 3) compliance review; and 4) change orders. Importantly, once the compliance review function has been completed, only an authorized user can make subsequent changes to the ad.

Initially, a user needs to log-in to the system. During log-in, the user establishes himself/herself as an authorized user. After log-in, the now authorized user selects a set-up option. In particular, this function essentially requires the user to select between 1) creating a new ad; and 2) editing or modifying an existing ad. In either case, the user defines a theme for the ad, and specifies the ad run dates. Also, a control number is specified for the ad. Once all of this has been accomplished, the user then proceeds to input data for the ad.

As envisioned for the present invention, in the operation of the data input function group, data pertaining to both the product description, location and to the terms of the transaction are input into the system. In general, the product description data will include such information as the year of manufacture, the name of the manufacturer, product model (if applicable), optional equipment and upgrades (if applicable), quantity available, and inventory/stock number. On the other hand, the user-selected data pertains more to the terms for the sale of a product(s), and will include such information as the condition of the product being sold, an ad layout, actual terms of sale, and an expiration date for the offer to sell. Based on this user-selected data, the system and method of the present invention may then prompt the user for additional information. Specifically, these prompts will require the user to respond with whatever additional information may be required to eventually determine legal compliance.

For compliance review, the input data is evaluated from several perspectives. Specifically, the required legal guidelines for publishing the advertisement are determined. This determination depends, at least in part, on whether the ad is a print ad, a magazine ad or a radio/tv ad. In each case, a compliant, sample ad layout(s) is then provided for viewing, along with the required disclosures. At this point the compliant ad can take one of several forms. For instance, it can be a completed sample ad, it can be in unformatted text, or it can be in text with applicable legal disclosure. Further, the compliant ad can be color coded to denote new ads, modified ads, and unchanged ads. In any event, the user can review the ad disclosures and layout guidelines that are required for the ad to be compliant. The user can then accept the compliant ad and send it on for further review by an advertiser or publisher.

Change orders to create, edit, delete or otherwise modify a compliant ad can be done as desired, but only by an authorized user. Importantly, in all cases, the method and system of the present invention requires that ads be created and edited by only authorized users. Further, regardless how an ad may be changed, the method and system of the present invention provides all of the information that is necessary for legal compliance with applicable jurisdictional requirements.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is logic flow chart showing the functional aspects of the set-up options in the computer program of the present invention;

FIG. 1B is logic flow chart showing the functional aspects for data input in the computer program of the present invention;

FIG. 1C is logic flow chart showing the compliance review functions of the computer program of the present invention; and

FIG. 1D is logic flow chart showing the functional aspects of the change order capabilities in the computer program of the present invention.

### DESCRIPTION OF THE PREFERRED EMBODIMENTS

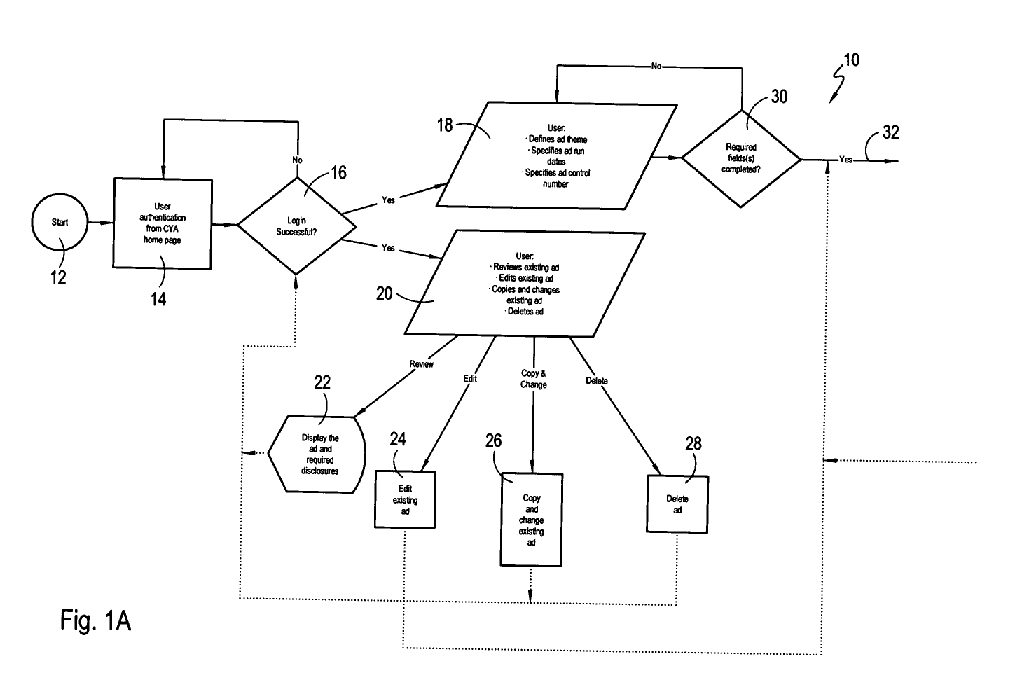

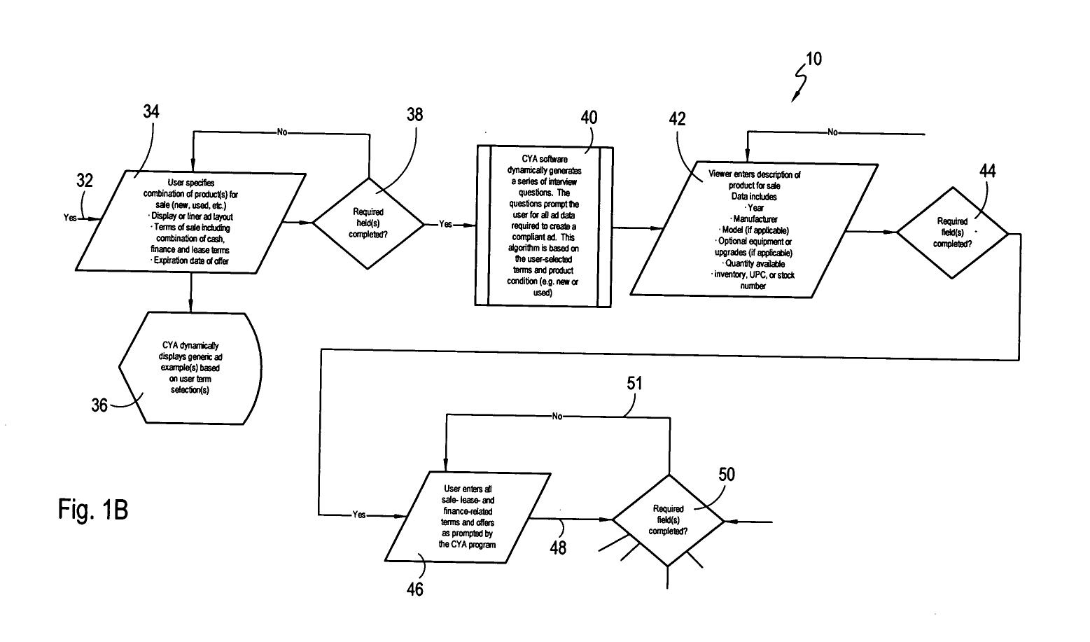

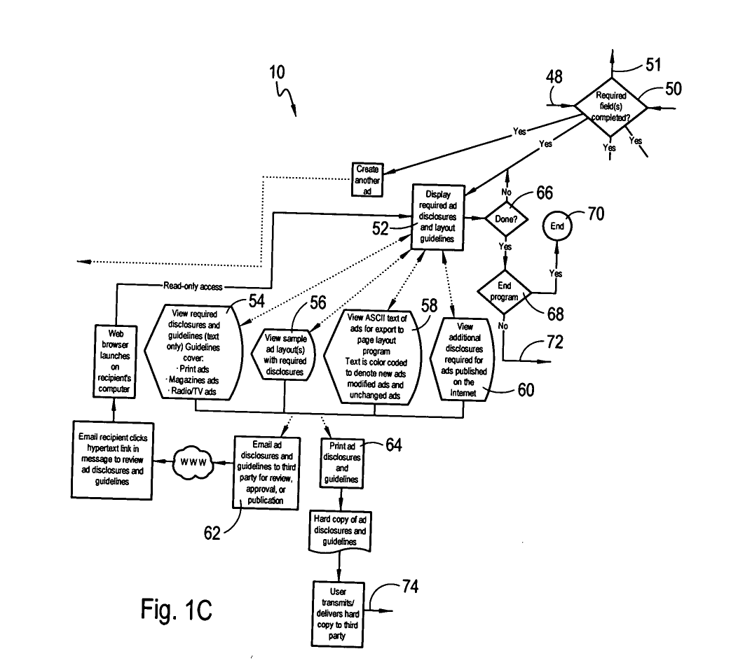

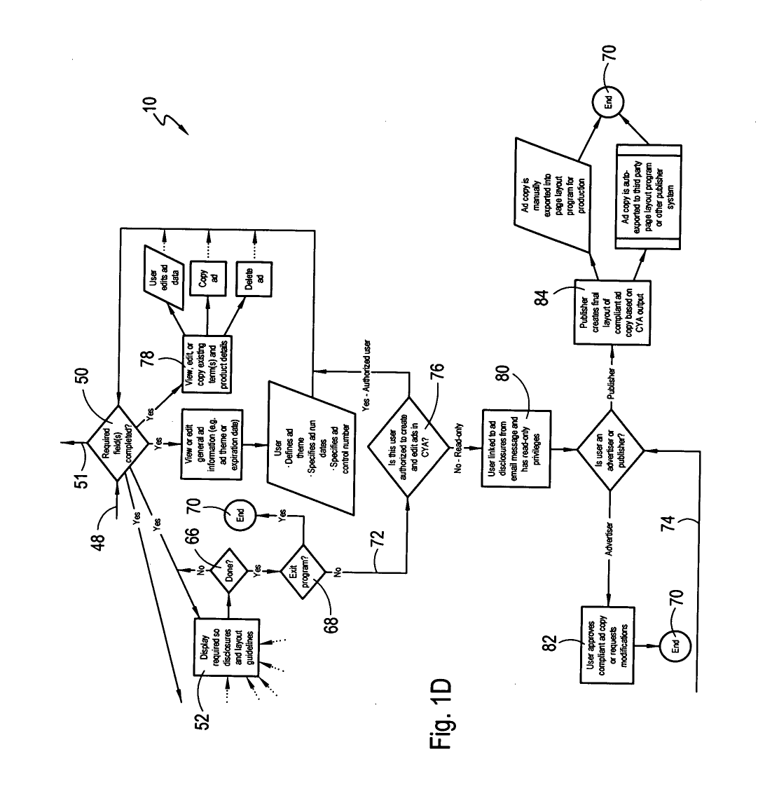

Referring collectively to FIGS. 1A, 1B, 1C and 1D, a computer system in accordance with the present invention is shown in logic flow chart form and is generally designated 10. In FIG. 1A, it will be seen that an operation of the system 10 begins at a start point 12 and requires the user to initially participate in an authentication procedure, as shown by action block 14. If the authentication is successful, as determined by inquiry block 16, the user is then an authorized user and can select the set-up option of either creating a new ad (task block 18) or reevaluating an existing ad (task block 20). As shown by task block 20, for an already existing ad, the user can either review the ad (block 22), edit the ad (block 24), copy and change the existing ad (block 26) or delete the ad (block 28). In selected instances, the reevaluation of an existing ad may require a return to the task block 18. If so, as is done with a new ad, task block 18 requires that the user define the ad theme, specify ad run dates or specify an ad control number. As shown in FIG. 1A, once inquiry block 30 has determined that the activities of task block 18 have been completed, line 32 indicates the operation of system 10 moves to the data input functional group shown in FIG. 1B.

As seen in FIG. 1B action block 34 shows that the first requirement of the data input functional group is to provide input about transaction terms (e.g. finance terms, lease terms, and expiration date) and the condition of the product (e.g. new or used). This data, pertaining to the transaction, is input into the system 10 in the form of user-selected terms and can be displayed for review by the user (display block 36). As further shown, when the required field(s) for action block 34 have been completed, inquiry block 38 advances the operation of system 10 to interactive block 40. Specifically, as indicated by interactive block 40, the system 10 prompts the user to provide additional input regarding a description of the product. This is done be a dynamically generated series of interview questions that will eventually lead to a compliant ad.

Action block 42 in FIG. 1B indicates that in response to prompts (i.e. interview questions) from system 10, the user is required to give specific information about the product being sold. By way of example, FIG. 1B has been presented with interview questions that pertain to the sale of an automobile. In this example, the year, make, model, optional upgrades, quantity available and stock numbers for the automobile to be sold have been suggested. It will be appreciated by the skilled artisan, however, that for other type products, other applicable interview questions could as well have been presented. For instance, the methods of system 10 are equally applicable for real estate, employment and furniture ads, as well as ads for a wide variety of goods in general. In any event, when this questioning has been completed (as determined by inquiry block 44), the user is again prompted at action block 46 to provide whatever additional input may be necessary for compliance. This additional prompting is based on all of the previous input. Line 48 then indicates that once all of the appropriate data has been input, the operation of system 10 moves to inquiry block 50. There, in a monitoring function that is similar to earlier operations, the inquiry block 50 and the return line 51 indicate that the total input data function is monitored for completeness before the operation of system 10 proceeds to the compliance review functional group shown in FIG. 1C.

In overview, the functional aspects of compliance review are collectively directed toward the generation of a compliant ad. As shown in FIG. 1C, the central aspect of this function is accomplished by the interaction between the action block 52 and the view blocks 54, 56, 58 and 60. When considered together, these blocks indicate that a compliant ad may be in the form of either unformatted text (view block 54) or a sample ad (view block 56). Further, the text with legal disclosure may be color coded to denote new ads [black], modified ads [orange], edited ads [purple] and unchanged ads (view block 58). Additionally, mandatory language may be highlighted in red. Still further, view block 60 indicates that compliance requirements for special circumstances, such as ads to be published on the internet, are also considered. In any event, the result is a compliant ad that is ready to be prepared for publishing.

Once a compliant ad has been generated, the system 10 allows several additional actions to be accomplished. For one, as indicated by action block 62, the compliant ad can be passed via email and the internet to a third party for review, approval or publication. For another, action block 64 indicates that the compliant ad can be printed in hard copy. Further, the inquiry blocks 66 and 68 indicate that the user can simply move to end point 70 and terminate the operation of system 10. On the other hand, lines 72 and 74 indicate that the operation of system 10 can be passed to the change order functional group shown in FIG. 1D.

As will be appreciated from the position of inquiry block 76, only an authorized user can view, edit, copy or delete a compliant ad (see action block 78). Otherwise, in order to protect the legal compliance of system 10, there are only “read only” privileges (action block 80). At this point, depending on whether the user is now an advertiser (action block 82) or a publisher (action block 84), the compliant ad is used as desired, and the operation of system 10 goes to the end point 70.

While the particular System and Method for Advertising Compliance as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A computerized method for adapting an advertisement (ad) for a user to be in legal compliance with applicable jurisdictional requirements, the method comprising the steps of:
selecting a set-up option;
providing user-selected input data for the ad, wherein the user-selected input data includes transaction terms for the sale of a product;
responding to prompts for the additional input of product description data, wherein the prompts are based on the user-selected input data;
reviewing ad disclosures and layout guidelines required for the input product description data and the transaction terms, wherein the ad disclosure and layout guidelines are generated in response to a completion of the providing step and the responding step; and
accepting a compliant ad.

2. A method as recited in claim 1 wherein the selecting step is accomplished by making a selection between creating a new ad and editing an existing ad.

3. A method as recited in claim 1 wherein the user-selected data comprises a condition of the product being sold, an ad layout, terms of sale, and an expiration date of an offer to sell.

4. A method as recited in claim 1 wherein the product is an automobile and the product description data comprises year of manufacture, manufacturer, product model (if applicable), optional equipment and upgrades (if applicable), quantity available, and inventory/stock number.

5. A method as recited in claim 1 further comprising the step of editing the compliant ad.

6. A method as recited in claim 5 wherein the editing step is accomplished by an authorized user and further comprises the steps of:
removing discriminatory terms and descriptions; and
excising illegal terminology.

7. A method as recited in claim 1 further comprising the step of publishing the compliant ad.

8. A method as recited in claim 1 further comprising the step of color coding the compliant ad to denote new ads, modified ads, and unchanged ads.

9. A method as recited in claim 1 wherein the compliant ad is selected from a group consisting of a sample ad, unformatted text, and text with legal disclosure.

10. A computerized method for adapting an advertisement (ad) for a user to be in legal compliance with applicable jurisdictional requirements, the method comprising the steps of:
presenting the user with a set-up option;
requiring the user to input user-selected data for the ad, wherein the user-selected data includes transaction terms for the sale of a product;
prompting the user for additional input of product description data, wherein the prompts are based on the user-selected input data;
displaying ad disclosures and layout guidelines for review by the user, as required for the input product description data and the transaction terms, wherein the ad disclosure and layout guidelines are generated in response to a completion of the requiring step and the prompting step; and
having the user accept a compliant ad.

11. A method as recited in claim 10 wherein the presenting step is accomplished when the user selects between creating a new ad and editing an existing ad.

12. A method as recited in claim 10 further comprising the step of editing the compliant ad.

13. A method as recited in claim 12 wherein the editing step is accomplished by an authorized user and further comprises the steps of:
removing discriminatory terms and descriptions; and
excising illegal terminology.

14. A method as recited in claim 10 further comprising the step of publishing the compliant ad.

15. A method as recited in claim 10 further comprising the step of color coding the compliant ad to denote new ads, modified ads, and unchanged ads.

16. A computer system for adapting an advertisement (ad) for a user to be in legal compliance with applicable jurisdictional requirements which comprises:
a means for presenting the user with a set-up option;
a means for requiring the user to input user-selected data for the ad, wherein the user-selected data includes transaction terms for the sale of a product;
a means for prompting the user for additional input of product description data, wherein the prompts are based on the user-selected input data;
a means for displaying ad disclosures and layout guidelines for review by the user, as required for the input product description data and transaction terms, wherein the ad disclosure and layout guidelines are generated in response to completion of the requiring step and the prompting step; and
a means for having the user accept a compliant ad.

17. A system as recited in claim 16 wherein the user-selected data comprises a condition of the product being sold, an ad layout, terms of sale, and an expiration date of an offer to sell.

18. A system as recited in claim 16 wherein the product description data comprises year of manufacture, manufacturer, product model (if applicable), optional equipment and upgrades (if applicable), quantity available, and inventory/stock number.

19. A system as recited in claim 16 further comprising a means for editing the compliant ad.

20. A system as recited in claim 16 further comprising a means for color coding the compliant ad to denote new ads, modified ads, and unchanged ads.
